(19) United States
(12) Patent Application Publication
(10) Pub. No.: US 2014/0293408 A1
(43) Pub. Date: Oct. 2, 2014

(54) AUXILIARY ARM ATTACHING STRUCTURE OF STAND APPARATUS

(71) Applicant: MITAKA KOHKI CO., LTD., Tokyo (JP)

(72) Inventors: Katsuyuki NAKAMURA, Tokyo (JP); Masao DOI, Tokyo (JP); Katsushige NAKAMURA, Tokyo (JP)

(73) Assignee: MITAKA KOHKI CO., LTD., Tokyo (JP)

(21) Appl. No.: 14/228,688

(22) Filed: Mar. 28, 2014

(30) Foreign Application Priority Data
Apr. 1, 2013 (JP) 2013-075677

(51) Int. Cl. G02B 21/36; G02B 21/22; G02B 21/00

(52) U.S. Cl. CPC G02B 21/368; G02B 21/0012; G02B 21/22
USPC 359/376; 359/368

(57) ABSTRACT

An auxiliary arm attaching structure of a stand apparatus 1 includes a front member 3 that is attached to a support arm 2 of the stand apparatus and has a projection 6. The projection projects in a direction different from a longitudinal direction of the support arm and supports an auxiliary arm 8. Supported with the projection, the auxiliary arm is turnable so that an electronic image display unit 9 attached to a front end of the auxiliary arm is turnable to any position around a surgical microscope 4 supported with the front member.

### BACKGROUND OF THE INVENTION

1. Field of the Invention

The present invention relates to an auxiliary arm attaching structure of a stand apparatus.

2. Description of Related Art

The stand apparatus is an apparatus for supporting a surgical microscope at a front end of a support arm of the stand apparatus. The surgical microscope is used for, for example, neurosurgery and has a pair of eyepieces to let a main operator stereoscopically observe a surgical site.

Operation of the surgical site is carried out not only by the main operator but also with the help of an assistant. For this, the stand apparatus has an auxiliary arm to attach an electronic image display unit thereto so that the assistant may observe, on the display unit, an image of the surgical site which is observed by the main operator through the surgical microscope. In connection with this, Japanese Unexamined Patent Application Publication No. 2008-237232 installs a camera on the surgical microscope to photograph the surgical site and create a pair of electronic images having binocular parallax. The electronic images are displayed on the electronic image display unit so that the assistant may three-dimensionally observe the surgical site.

### SUMMARY OF THE INVENTION

According to the related art, the auxiliary arm that supports the electronic image display unit has a limited turning range, and therefore, is unable to move the display unit to an optional position around the surgical microscope.

In consideration of the problem of the related art, the present invention provides an auxiliary aim attaching structure of a stand apparatus capable of supporting an electronic image display unit at any position around a surgical microscope.

According to an aspect of the present invention, the auxiliary arm attaching structure includes a front member attached to a support arm horizontally extending from the stand apparatus, a projection formed on the front member and horizontally projecting in a direction different from a longitudinal direction of the support arm, an auxiliary arm having a base end attached to the projection so as to horizontally turnable, and an electronic image display unit supported at a front end of the auxiliary arm.

### BRIEF DESCRIPTION OF THE DRAWINGS

FIG. 1 is a side view illustrating an auxiliary arm attaching structure of a stand apparatus according to an embodiment of the present invention;

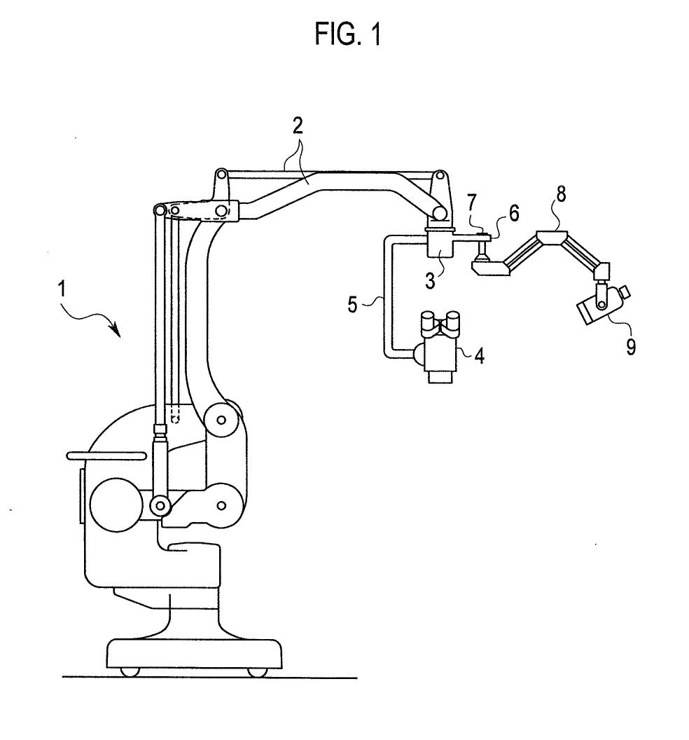

FIG. 2 is a perspective view illustrating the auxiliary arm attaching structure of the stand apparatus; and

FIG. 3 is a plan view illustrating a turning range of an auxiliary arm of the auxiliary arm attaching structure.

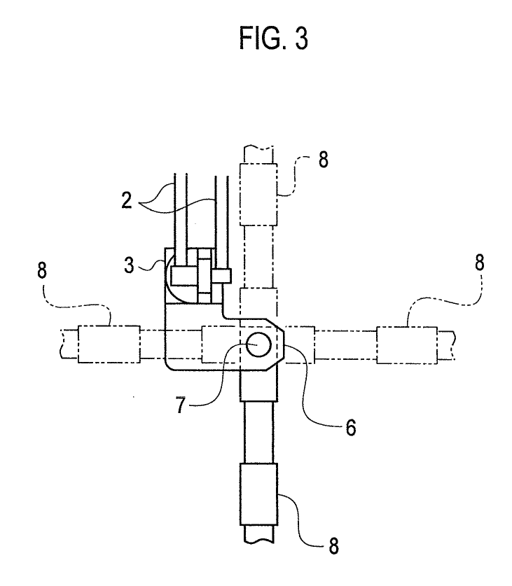

### DESCRIPTION OF PREFERRED EMBODIMENTS

An auxiliary arm attaching structure of a stand apparatus according to an embodiment of the present invention will be explained with reference to the drawings.

The stand apparatus 1 has a support arm 2 extending in a horizontal direction. The support arm 2 has a parallel linkage structure that maintains verticality of a front member 3, which is attached to a front end of the support arm 2, whenever the support arm 2 is vertically moved. The front member 3 is turnable around a virtual vertical axis that passes through a front vertical link of the parallel linkage structure of the support arm 2.

The front member 3 has a U-shaped suspension arm 5 that supports a surgical microscope 4. The surgical microscope 4 incorporates an objective optical system, a zoom optical system, and an eyepiece optical system. The surgical microscope 4 also has a pair of eyepieces through which a main operator A is able to stereoscopically observe optical images having binocular parallax of a surgical site in an orientation in which the main operator A faces the surgical site. The surgical microscope 4 is provided with a camera (not illustrated) capable of three-dimensionally photographing the surgical site.

The front member 3 integrally has a projection 6. The projection 6 extends in nearly an L-shape in a virtual plane that is horizontal with respect to the vertical axis of the front member 3. The projection 6 projects in a lateral direction relative to a longitudinal direction of the support arm 2. More precisely, the projection 6 has a supporting point 7 that is spaced away from the front member 3 in a front direction angled at theta (θ) of about 45 degrees with respect to the longitudinal direction of the support arm 2. At the supporting point 7, the projection 6 supports a base end (first end) of an auxiliary arm 8 so that the auxiliary arm 8 is able to horizontally turn. A turn axis of the auxiliary arm 8 is at the supporting point 7, is displaced from the virtual vertical axis of the front member 3, and is in parallel with the same. The supporting point 7 is shifted from the vertical axis of the front member 3 so that the auxiliary arm 8 never interferes with the front member 3 when the auxiliary arm 8 is turned. A front end (second end) of the auxiliary arm 8 supports an electronic image display unit 9. The display unit 9 displays a pair of left and right electronic images having binocular parallax of the surgical site photographed by the camera of the surgical microscope 4, so that an assistant B is able to stereoscopically observe the surgical site through the display unit 9.

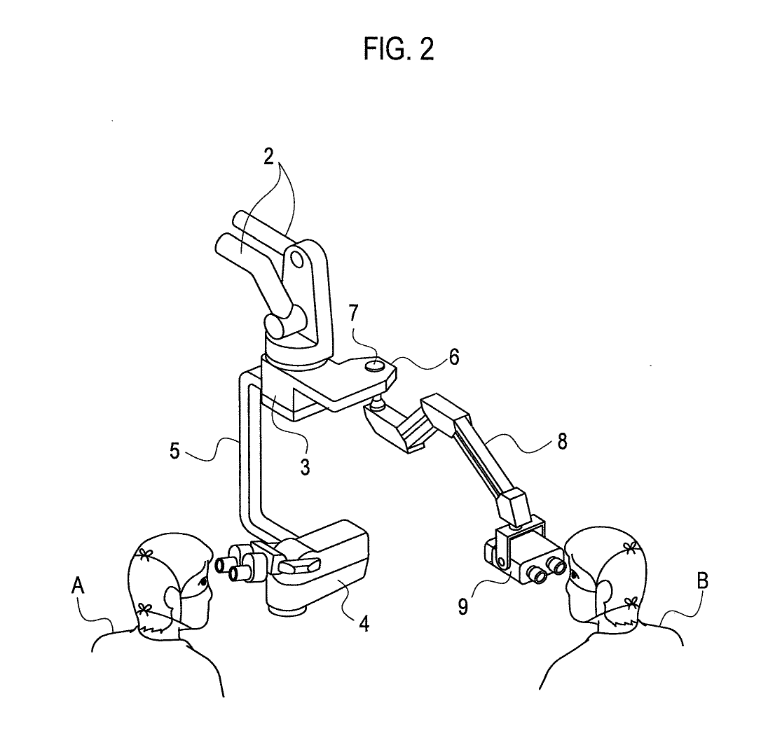

In FIG. 2, the assistant B is on the right side of the main operator A. Depending on situations, the assistant B must move to an optional location around the surgical microscope 4 handled by the main operator A. At this time, the auxiliary arm 8 is turned around the supporting point 7 to move the electronic image display unit 9 to a required position around the main operator A and allow the assistant B to observe the surgical site with the display unit 9 at the position. The suspension arm 5 is supported by the front member 3 and the auxiliary arm 8 is supported at the supporting point 7 that is offset from the vertical axis of the front member 3, and therefore, the auxiliary arm 8 with the display unit 9 never interferes with the suspension arm 5 having the surgical microscope 4 when the auxiliary arm 8 is turned around the supporting point 7.

The surgical microscope 4 and electronic image display unit 9 are supported with the front member 3 that is always kept vertical, and therefore, turning the support arm 2 relative to the stand apparatus 1 results in translating the surgical microscope 4 and display unit 9 in vertical and horizontal directions without changing their attitudes or positional relationships. With this, the surgical microscope 4 and display unit 9 allow the main operator A and assistant B to easily observe the surgical site.

The assistant B is able to independently observe the surgical site through the electronic image display unit 9 supported with the auxiliary arm 8. Even if the main operator A moves the surgical microscope 4, the display unit 9 is stationary to exert no influence on the observation by the assistant B. The assistant B is able to stereoscopically observe the surgical site through the display unit 9, and therefore, is able to correctly assist the main operator A. This results in shortening an operation time and reducing burden on the main operator A. Together with the electronic images of the surgical site, the display unit 9 may display information concerning CT, MRI, navigation, and the like.

In this way, the present invention forms the projection on the front member of the support arm of the stand apparatus so that the projection projects in a direction different from the longitudinal direction of the support arm. The projection turnably supports the auxiliary arm. The turn axes of the auxiliary arm and front member are in parallel with each other and are spaced from each other. Accordingly, the auxiliary arm hardly interferes with the front member, and therefore, the electronic image display unit supported with a front end of the auxiliary arm is movable to any position around the surgical microscope supported with the front member.

A base end of the auxiliary arm is attached to the supporting point of the projection that forwardly protrudes from the front member in a direction biased by about 45 degrees. Accordingly, the auxiliary aim is freely turnable around the supporting point.

The electronic image display unit is configured to provide an assistant who works on the display unit with stereoscopically observable images, and therefore, the assistant is able to correctly assist a main operator who works on the surgical microscope.

This application claims benefit of priority under 35USC §119 to Japanese Patent Application No. 2013-075677, filed on Apr. 1, 2013, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An auxiliary arm attaching structure of a stand apparatus, comprising:
a front member attached to a support arm horizontally extending from the stand apparatus, the front member being turnable around a vertical turn axis defined on the support arm;
a projection formed on the front member and horizontally projecting in a direction different from a longitudinal direction of the support arm;
an auxiliary arm having a first end attached to the projection at a position shifted from the vertical turn axis, the auxiliary arm being turnable around a turn axis that is defined in parallel with the vertical turn axis at the position where the first end is attached to the projection; and
an electronic image display unit supported at a second end of the auxiliary arm to display electronic images.

2. The auxiliary arm attaching structure of claim 1, wherein the turn axis of the auxiliary arm defined at the position where the first end is attached to the projection is spaced away from the vertical turn axis defined on the support arm in a direction that substantially forms 45 degrees in a virtual horizontal plane with respect to the longitudinal direction of the support atm.

3. The auxiliary arm attaching structure of claim 1, wherein the electronic image display unit is configured to display images that are stereoscopically observable.
